(19) United States
(12) Patent Application Publication
(10) Pub. No.: US 2008/0259251 A1
(43) Pub. Date: Oct. 23, 2008

(54) GREEN EMITTING PHOSPHOR, LIGHT EMITTING DEVICE INCLUDING THE SAME, AND LIQUID CRYSTAL DISPLAY DEVICE INCLUDING LIGHT EMISSION DEVICE AS BACKLIGHT UNIT

(75) Inventors: Gyeong-Jae HEO, Yongin-si (KR); Yong-Chan YOU, Yongin-si (KR); Kyu-Chan Park, Yongin-si (KR); Do-Hyung Park, Yongin-si (KR); Sang-Hyuk Park, Yongin-si (KR); Sun-Hwa Kwon, Yongin-si (KR); Jae-Woo Bae, Yongin-si (KR); Young-Suk Cho, Yongin-si (KR); Hui-Young Ku, Yongin-si (KR); Ui-Song Do, Yongin-si (KR); Yoo-Jung Lee, Yongin-si (KR); Jin-Hyoung Seo, Yongin-si (KR); Ji-Hyun Kim, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/039,114

(22) Filed: Feb. 28, 2008

(30) Foreign Application Priority Data
Apr. 23, 2007 (KR) 2007-39381

(51) Int. Cl. G02F 1/1335; C09K 11/08; H01J 1/62

(52) U.S. Cl. 349/69; 252/301.4 R; 313/487

(57) ABSTRACT

A green emitting phosphor of the following composition: Sr₁₋ₓBaₓGa₂S₄:yEu²⁺, where 0.01≦x≦0.9 and 0.01≦y≦0.1. The green emitting phosphor can be applied to a light emitting device due to having light emitting peaks at a short wavelength of 522 to 535 nm and improved color coordinate characteristics. The green emitting phosphor can improve lifespan characteristics of the light emitting device:

### CROSS-REFERENCE TO RELATED APPLICATIONS

This application claims the benefit of Korean Application No. 2007-39381, filed on Apr. 23, 2007, in the Korean Intellectual Property Office, the disclosure of which is incorporated herein by reference.

### BACKGROUND OF THE INVENTION

1. Field of the Invention

Aspects of the present invention relate to a green emitting phosphor, a light emitting device including the same, and a liquid crystal display including the light emitting device as a backlight unit. More particularly, aspects of the present invention relate to a green emitting phosphor that can be applied to a light emitting device due to having light emitting peaks with a short wavelength, excellent color coordinate characteristics, and improved lifespan characteristics, and a light emitting device including the same, and a liquid crystal display including the light emitting device as a backlight unit.

2. Description of the Related Art

An example of a self-light emitting display device is a field emission display (FED) that displays text or images based on electron emission caused by an electric field. Technology for utilizing the FED as a backlight unit is widely known.

An FED basically includes a vacuum container that is formed of a first substrate, a second substrate, and a sealing member; an electron emission unit that is disposed on one side of the first substrate and composed of electron emission regions and driving electrodes; and a light emission unit that is disposed on one side of the second substrate and composed of a phosphor layer and an anode.

The electron emission regions emit arbitrary electrons for each pixel in response to a driving signal applied to the driving electrodes, and the anode receives a direct current voltage of thousands of volts and accelerates the electrons toward the phosphor layer. Then, the electrons make the phosphor layer of corresponding pixels emit light, thereby forming a predetermined image on a screen.

As for the phosphor of the phosphor layer, researchers are studying fluorescent or phosphorescent substances of diverse structures.

European Patent Application No. 02021172.8 suggests the use of MSi₂O₂N₂:Eu, where M is at least one of Sr, Ba, and Ca, as a phosphorescent substance. The phosphorescent substance is problematic in that at high temperatures the light emitting efficiency is decreased and the color locus severely fluctuates.

In addition, Korean Patent Publication No. 2006-0094528 discloses the phosphorescent substance SrSi₂N₂O₂:Eu²⁺, and Korean Patent Publication Nos. 2006-0024360 and 2006-0061929 disclose the use of the phosphorescent substance Sr₁₋ₓCaₓGa₂S₄:yEu²⁺.zGa₂S₃ where 0.0001≦x≦1, 0.001≦y≦0.1, and 0.0001≦z≦0.2.

However, the phosphorescent substances are not satisfactory with respect to efficiency and color characteristics, and a phosphorescent substance with a better efficiency and color characteristics is required.

### SUMMARY OF THE INVENTION

Aspects of the present invention provide a green emitting phosphor having light emitting peaks at a short wavelength and excellent color coordinate characteristics.

Aspects of the present invention also provide a light emitting device including the green emitting phosphor, and a liquid crystal display including the light emitting device as a backlight unit.

According to an embodiment of the present invention, provided is a green emitting phosphor having the following Formula 1:

Sr₁₋ₓBaₓGa₂S₄:yEu²⁺ Formula 1

wherein 0.01≦x≦0.9 and 0.01≦y≦0.1.

The green emitting phosphor of Formula 1 has light emitting peaks ranging from 522 to 535 nm, and the light emitting peaks have a bandwidth of less than 50 nm under excitement from a 440 nm±40 nm light source.

According to an embodiment of the present invention, provided is a light emitting device including the green emitting phosphor of Formula 1.

The light emitting device includes a first substrate and a second substrate disposed opposite to each other, an electron emission unit disposed on one side of the first substrate, and a light emission unit disposed on one side of the second substrate. Herein, the light emission unit includes a plurality of phosphor layers with spaces therebetween on one side of the second substrate.

The phosphor layers include white phosphor where the red, green, and blue phosphors are mixed, and the green phosphor includes a green emitting phosphor that is expressed as Formula 1.

According to yet another embodiment of the present invention, provided is a liquid crystal display including the light emitting device and a liquid crystal panel assembly that is disposed in the fore part of the light emitting device, that receives light emitted from the light emitting device, and that displays images.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view describing a light emitting device according to an embodiment of the present invention.

FIG. 2 is a partially exploded perspective view illustrating the light emitting device of FIG. 1.

FIG. 3 is an exploded perspective view showing a liquid crystal display (LCD) according to an embodiment of the present invention.

FIG. 4 is a light emission spectrum of phosphors prepared according to Comparative Example 1 and Examples 1 to 3.

FIG. 5 shows an XRD diffraction pattern of the phosphor prepared according to Example 1.

FIG. 6 shows an XRD diffraction pattern of a phosphor prepared according to Example 4.

FIG. 7 is a graph showing variance in light emission intensities of the phosphor prepared according to Example 4 and conventional phosphors BaGa₂S₄:Eu, SrGa₂S₄:Eu, and ZnS:(Cu,Al) according to time.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Aspects of the present invention utilize strontium barium thiogallate as a green emitting phosphor, the form of which is expressed as the following empirical Formula 1:

Sr₁₋ₓBaₓGa₂S₄:yEu²⁺ Formula 1

wherein 0.01≦x≦0.9 and 0.01≦y≦0.1. The ranges of x and y may be 0.01≦x≦0.3 and 0.01≦y≦0.08, respectively, and more specifically 0.01≦x≦0.25 and 0.01≦y≦0.05.

The green emitting phosphor of Formula 1 moves toward the area where the maximum light emitting peaks appear at shorter wavelengths when compared to the light emission spectrum of a conventionally known strontium thiogallate phosphor (SrGa₂S₂:Eu²⁺). The light emitting peaks vary according to the mole ratio of Ba. The green emitting phosphor has light emitting peaks in a range of 522 to 535 nm. The light emitting peaks have a bandwidth of less than 50 nm under excitement by a 440 nm±40 nm light source.

Herein, the Eu may be used alone. If necessary, the chrominance of the phosphor can be controlled by adding a rare earth element thereto. The rare earth element may be one selected from the group consisting of Sc, Y, La, Ce, Pr, Nd, Gd, Tb, Ho, Er, Tm, Lu, Sm, Eu, Dy, Yb, and combinations thereof, and more specifically it may be one selected from the group consisting of Ce, Tb, Ho, Sm, Yb, Nd, and combinations thereof.

The green emitting phosphor of Formula 1 is of a green color having superior color purity over the conventionally known thiogallate phosphors. The green emitting phosphor of Formula 1 has excellent color purity having an X value ranging from about 0.2700 to 0.2200 and a Y value ranging from about 0.7040 to 0.7010 in the CIE XYZ color space. Also, the green emitting phosphor of formula 1 has a uniform light emitting strength for a long time and has excellent luminescence when compared to the related art.

The green emitting phosphor may be prepared by modifying known preparation methods, but the preparation method is not thereby limited.

The green emitting phosphor of Formula 1 may be prepared according to the following method.

First, an aqueous mixed metal salt solution is prepared by loading an aqueous metal salt solution including gallium and an aqueous metal salt solution including europium into a reactor and uniformly mixing them.

For the metal salt, a sulfate, a nitrate, an acetate, or a halide including gallium or europium may be used. However, the kind of metal salt is not limited to specific salts. The importance of the salt is that the salt can be dissolved in water as the salt is merely a delivery system for the metal ions. According to aspects of the current invention, a nitrate salt is used.

The content of the gallium salt and the europium salt in the mixed metal salt aqueous solution is controlled to satisfy the stoichiometric ratio defined in Formula 1.

Subsequently, a gallium-europium precipitate is acquired by adding an alkali chelating agent to the reactor to thereby form a complex compound of the alkali chelating agent and the gallium salt or the europium salt.

Non-limiting examples of the alkali chelating agent include ammonium carbonate, an ammonia aqueous solution, an ammonium sulfate aqueous solution, and mixtures thereof.

The gallium-europium precipitate is then collected and a strontium-barium-gallium-europium precursor is acquired by mixing the gallium-europium precipitate with strontium oxide and barium oxide.

The strontium oxide and the barium oxide may be purchased individually or they may be prepared in the form of a co-precipitation oxide by mixing their salts.

Subsequently, the strontium-barium-gallium-europium precursor is baked at a temperature ranging from about 500 to 850° C. in an atmosphere of hydrogen sulfide gas for about 1 to 10 hours to thereby prepare the green emitting phosphor of Formula 1. The baking may be performed more than once at increasing temperatures.

The green emitting phosphor of Formula 1 may be prepared according to other aspects of the present invention, which is described hereinafter.

First, a mixed metal salt aqueous solution may be prepared by uniformly mixing metal salt aqueous solutions including strontium, barium, and europium, respectively, in a reactor.

The metal salt may be a sulfate, a nitrate, an acetate, or a halide including strontium, barium, or europium. Again, the metal salt is not limited to a specific one, but those that are soluble in water may be used. The importance of the salt is that it separates from the metal ions in water. According to aspects of the current invention, the metal salt is a nitrate.

The concentrations of the metal salts are controlled during mixing so as to satisfy the stoichiometric ratio defined in Formula 1.

Subsequently, a strontium-barium precipitate is formed by adding an alkali chelating agent to the aqueous mixed metal salt solution. The alkali chelating agent and the strontium salt and barium salt form a complex compound. The europium salt is transformed into europium hydroxide.

As the alkali chelating agent, ammonium carbonate, an aqueous ammonia solution, an aqueous ammonium sulfate solution, and mixtures thereof may be used.

For example, when metal nitrate salts are used with ammonium carbonate as the alkali chelating agent, the reaction occurs as shown in the following Reaction Scheme 1:

Reaction Scheme 1

Sr(NO₃)₂+Ba(NO₃)₂+Eu(NO₃)₂+(NH₄)₂CO₃→Sr_{1-X}Ba_{X}CO₃↓+Eu(OH)₃↓+NH₄OH

Referring to Reaction Scheme 1, the strontium salt and the barium salt are transformed into Sr_{1-X}Ba_{X}CO₃ by the ammonium carbonate, and the europium salt is transformed into europium hydroxide (Eu(OH)₃).

Along with the strontium-barium precipitate, the europium hydroxide also precipitates out of the solution. Thus, the strontium-barium-europium precipitate is acquired by collecting the europium hydroxide and adding the aforementioned alkali chelating agent thereto.

Subsequently, a strontium-barium-europium sulfate is prepared by mixing the collected strontium-barium-europium precipitate with a sulfate compound such as ammonium sulfate and performing heat treatment at a temperature ranging from about 150 to 250° C. and then baking the mixture at a temperature of about 900 to 1200° C.

Subsequently, a precursor to the final green emitting phosphor is prepared by mixing the strontium-barium-europium sulfate with an aqueous gallium salt solution. The precursor is baked under an atmosphere of hydrogen sulfide gas at a temperature ranging from 500 to 850° C. for about 1 to 10 hours to produce the green emitting phosphor of Formula 1. The baking may be performed more than once at increasing temperatures.

According to another method, a strontium barium thiogallate phosphor may be prepared by mixing a strontium salt, a barium salt, gallium oxide, and europium oxide in a stoichiometric ratio, baking the mixture in the ambient atmosphere, pulverizing the baked mixture, and then baking it again under an atmosphere of hydrogen sulfide.

The green emitting phosphor of Formula 1 is used as a phosphor for many light emitting devices to improve brightness and lifespan thereof.

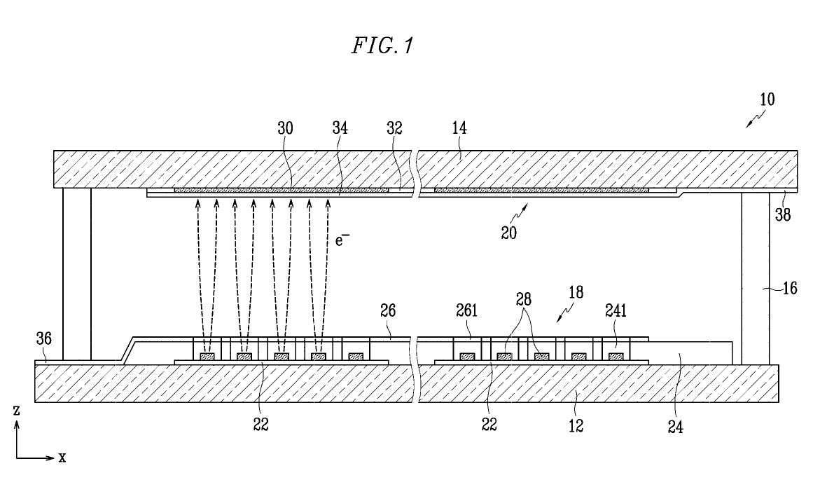

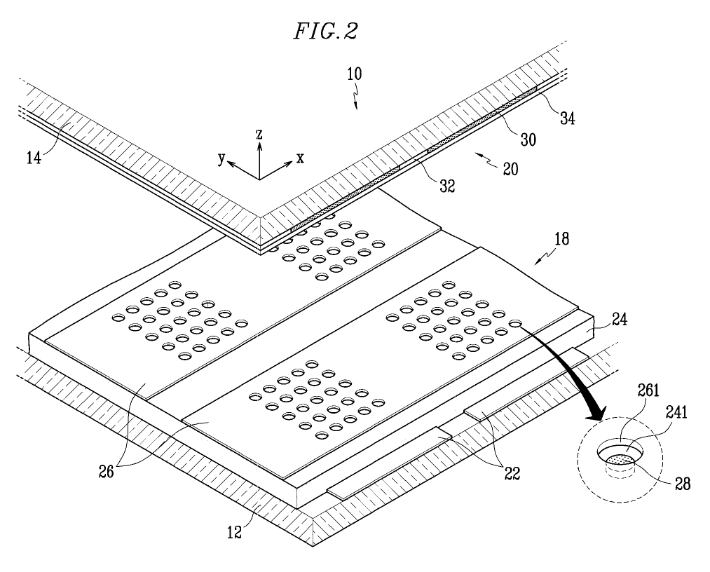

FIG. 1 is a cross-sectional view showing a light emitting device according to an embodiment of the present invention, and FIG. 2 is a partially exploded perspective view illustrating the light emitting device of FIG. 1.

Referring to FIG. 1, a light emitting device 10 suggested in the embodiment of the present invention includes a first substrate 12 and a second substrate 14 disposed in parallel and opposite to each other with a predetermined space between them. A sealing member 16 is disposed at the edges of the first substrate 12 and the second substrate 14 to seal the two substrates together, and the internal space therebetween is exhausted to a vacuum pressure of 10⁻⁶ Torr to thereby form a vacuum container.

The first substrate 12 and the second substrate 14 include a valid region for emitting actual visible light inside the sealing member 16 and an invalid region surrounded by the valid region. The valid region of the first substrate 12 includes an electron emission unit 18 for emitting electrons, and the valid region of the second substrate includes a light emission unit 20 for emitting visible light.

Referring to FIG. 2, the electron emission unit 18 is composed of cathodes 22, which are first electrodes formed in a stripe pattern along one direction of the first substrate 12, gate electrodes 26 that are second electrodes formed in a stripe pattern along a direction crossing the cathodes 22 with an insulation layer 24 therebetween, and electron emission regions 28 electrically connected to the cathodes 22.

The cathodes 22 may be disposed in parallel to the row direction of the first substrate 12, and the cathodes 22 may function as data electrodes by receiving scan signals. Also, the cathodes 22 may be disposed in parallel with the column direction of the first substrate 12, and the cathodes 22 may function as data electrodes by receiving scan signals.

Openings 261 and 241 may be formed in the gate electrodes 26 and the insulation layer 24, respectively, at intersection areas where the cathodes 22 and the gate electrodes 26 are crossed. The openings 261 and 241 expose parts of the surface of the cathodes 22, and the electron emission regions 28 are disposed on top of the cathodes 22 inside the openings 261 and 241 of the insulation layer 24.

The electron emission regions 28 may be formed of a material that emits electrons when an electric field is formed in the vacuum. For example, the material may be a carbon-based material or a nano-sized material. According to an embodiment, the electron emission regions 28 may include at least one selected from the group consisting of carbon nanotubes, graphite, graphite nanofiber, diamond, diamond-like carbon, fullerene, silicon nanowire, and combinations thereof. The electron emission regions 28 may be formed by a method such as screen printing, direct growing, chemical vapor deposition, and sputtering. According to another embodiment, the electron emission regions 28 may be formed of a material including molybdenum (Mo) or silicon (Si) as its major element in the form of a tip having a sharp point.

In the above-described structure, an intersection area of a cathode electrode 22 and a gate electrode 26 may correspond to one pixel region of the light emitting device 10, or more than two intersection areas may correspond to one pixel region of the light emitting device 10. In the latter case, more than two cathodes 22 and/or more than two gate electrodes 26 that correspond to one pixel region may be electrically connected to each other to receive the same driving voltage.

The light emission unit 20 also includes phosphor layers 30 having a predetermined pattern disposed on one surface of the second substrate 14 between the second substrate 14 and the first substrate 12, dark-colored layers 32 disposed between the phosphor layers 30, and a reflective metal layer 34 disposed on top of the phosphor layers 30 and the dark-colored layers 32.

The reflective metal layer 34 may function as an anode. When the reflective metal layer 34 is used as an anode, the reflective metal layer 34 becomes an accelerating electrode that attracts electron beams, receives a high voltage to maintain the phosphor layers 30 at a high potential state, and increases the brightness of the display by reflecting visible light emitted toward the first substrate 12 in a direction toward the second substrate 14 to combine with the visible light emitted by the phosphor layers 30 in a direction toward the second substrate 14.

Meanwhile, the anode may include a transparent conductive layer such as indium tin oxide (ITO), instead of the reflective metal layer 34. In this case, the anode is disposed between the second substrate 14 and the phosphor layers 30. The anode may be divided into a plurality of units of a predetermined pattern. Also, it is possible to form both a transparent conductive layer and a reflective metal layer 34 as the anode.

The phosphor layers 30 are white phosphor layers that emit white light. The white phosphor layers include a white phosphor substance realizing a white color by including red, green, and blue phosphors.

Herein, the green phosphor may be a green light emitting phosphor that is expressed as Formula 1.

The red and blue phosphors are not specifically limited in the embodiment of the present invention, and those conventionally used in the art can be used. Representatively, the red phosphor substance may include a compound selected from the group consisting of Y₂O₃:Eu, Y₂O₃:(Eu,Tb), Y₂O₂S:Eu, Y₂O₂S:(Eu,Tb), and combinations thereof. The blue phosphor substance may include a compound selected from the group consisting of ZnS:(Ag, Cl), ZnS:(Ag,Al), ZnS:(Ag,Al,Cl), and combinations thereof.

The phosphor layer 30 may be disposed in each pixel region, or more than two phosphor layers 30 may be disposed in each pixel region. Otherwise, one phosphor layer 30 may be disposed to be stretched over more than two pixel regions. In all three cases, each phosphor layer 30 may be formed in the shape of a square.

In addition, spacers (not shown) may be disposed between the first substrate 12 and the second substrate 14 to resist the compressive force applied to the vacuum container as a result of the vacuum and to maintain a uniform space between the two substrates.

The above-described light emitting device 10 is operated as a predetermined level of voltage is applied from the outside of the vacuum container to the cathodes 22, the gate electrodes 26, and the reflective metal layer 34 (acting as the anode). In FIG. 1, a gate lead line 36 extends from the gate electrodes 26, and an anode lead line 38 extends from the reflective metal layer 34.

When the cathodes 22 and the gate electrodes 26 receive a predetermined level of driving voltage, an electric field is formed around the electron emission regions 28 in a pixel region where the voltage difference between the cathodes 22 and the gate electrodes 26 reaches a potential greater than a threshold value. When the voltage difference between the cathodes and the gate electrodes is greater than the threshold value, electrons are emitted therefrom. The emitted electrons are attracted to the high voltage applied to the reflective metal layer 34, and collide with a corresponding area of the phosphor layers 30 resulting in the emission of light from the phosphor layers 30. The light emission intensity of the phosphor layers 30 in each pixel depends on the quantity of electrons delivered to the phosphor layers of each pixel.

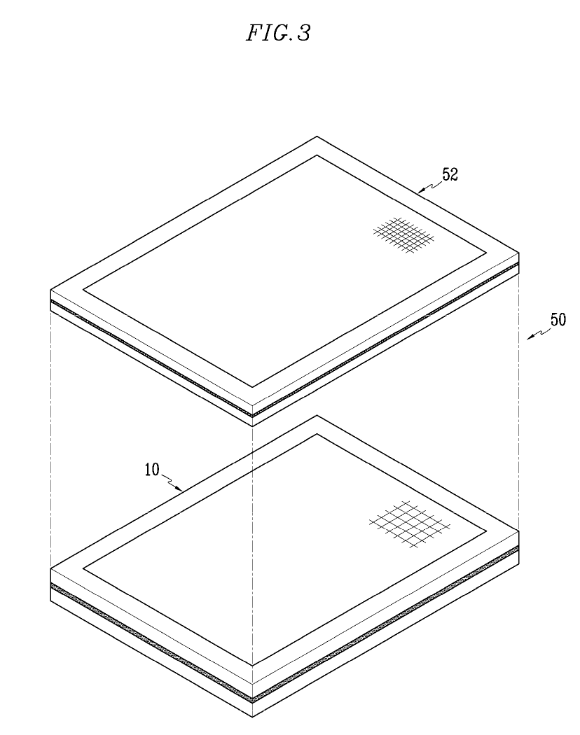

FIG. 3 is an exploded perspective view showing a liquid crystal display (LCD) according to an embodiment of the present invention.

Referring to FIG. 3, the LCD 50 of the present embodiment includes a liquid crystal panel assembly 52 having pixels in a row direction and a column direction and a light emitting device 10 disposed at the rear part of the liquid crystal panel assembly 52 to provide light to the liquid crystal panel assembly 52. For the liquid crystal panel assembly 52, all known liquid crystal panel assemblies may be used. The light emitting device 10 described in the above example functions as a backlight unit.

The following examples illustrate the present invention in more detail. These examples, however, should not in any sense be interpreted as limiting the scope of the present invention.

### EXAMPLES

### Example 1

### Preparation of Sr_{0.95}Ba_{0.05}Ga₂S₄:0.04Eu²⁺ Phosphor

Gallium-europium hydroxide (Ga(OH)₃/Eu(OH)₃) precipitate was acquired by mixing gallium nitrate (Ga(NO₃)₃) and europium nitrate (Eu(NO₃)₃) in a reactor at a molar ratio of 1:0.02 and adding ammonium hydroxide thereto.

A precursor to the Sr_{0.95}Ba_{0.05}Ga₂S₄:0.04Eu²⁺ phosphor was prepared by collecting the precipitate and adding strontium oxide and barium oxide to it. The quantities of the barium oxide and the strontium oxide were controlled to make a molar ratio for strontium:barium:gallium of 0.95:0.05:2.

Subsequently, the precursor was dried in an oven, pulverized, and baked in a tube-type furnace at 800° C. for 5 hours under an atmosphere of hydrogen sulfide to thereby prepare a strontium barium thiogallate phosphor.

### Example 2

### Preparation of Sr_{0.90}Ba_{0.1}Ga₂S₄:0.04Eu²⁺ Phosphor

A phosphor was prepared by the same method as Example 1, except that the quantity of barium was changed to be 10 mol %.

### Example 3

### Preparation of Sr_{0.85}Ba_{0.15}Ga₂S₄:0.04Eu²⁺ Phosphor

A phosphor was prepared by the same method as Example 1, except that the quantity of barium was changed to be 15 mol %.

### Example 4

### Preparation of Sr_{0.80}Ba_{0.20}Ga₂S₄:0.04Eu²⁺ Phosphor

A phosphor was prepared by the same method as Example 1, except that the quantity of barium was changed to be 20 mol %.

### Example 5

### Preparation of Sr_{0.75}Ba_{0.25}Ga₂S₄:0.04Eu²⁺ Phosphor

A phosphor was prepared by the same method as Example 1, except that the quantity of barium was changed to be 25 mol %.

### Example 6

### Preparation of Sr_{0.95}Ba_{0.05}Ga₂S₄:0.04Eu²⁺ Phosphor

Strontium carbonate, barium carbonate, gallium oxide, and europium oxide were mixed according to a stoichiometric ratio and baked at 1000° C. for 2 hours in the atmosphere. The baked oxide was pulverized and baked again at 800° C. for 5 hours under an atmosphere of hydrogen sulfide to prepare a strontium barium thiogallate phosphor.

### Comparative Example 1

### Preparation of SrGa₂S₄:0.04Eu²⁺ Phosphor

A gallium-europium hydroxide (Ga(OH)₃/Eu(OH)₃) precipitate was formed by mixing gallium nitrate (Ga(NO₃)₃) and europium nitrate (Eu(NO₃)₃) in a reactor at a molar ratio of 1:0.02 and adding ammonium hydroxide thereto.

A precursor to the SrGa₂S₄:0.04Eu²⁺ phosphor was prepared by collecting the precipitate and adding strontium oxide thereto. Subsequently, the precursor was dried in an oven, pulverized, and baked in a tube-type furnace at 800° C. for 5 hours under an atmosphere of hydrogen sulfide to prepare the strontium barium thiogallate phosphor.

### Experimental Example 1

### Light Emitting Spectrum Analysis

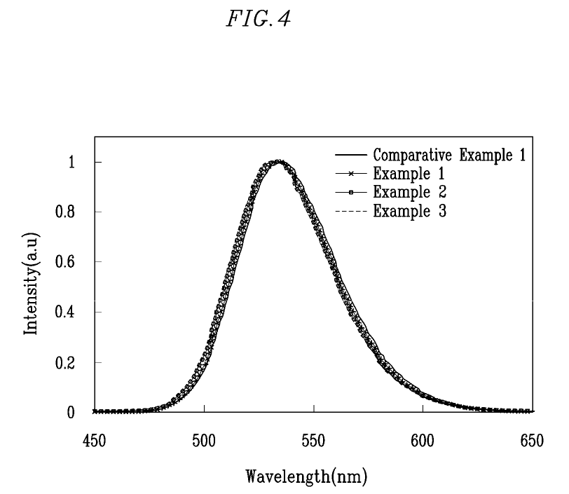

Light emitting peaks of the phosphors prepared according to Examples 1, 2, and 3 were measured and the results are shown in FIG. 4. Here, the reference phosphor was SrGa₂S₂:Eu²⁺.

FIG. 4 is a light emission spectrum of phosphors prepared according to Comparative Example 1 and Examples 1, 2, and 3.

Referring to FIG. 4, the phosphors of Examples 1, 2, and 3 showed maximum light emitting peaks at around 535 nm, and it could be seen that the higher the molar ratio of barium, the more the wavelength of the maximum light emitting peaks decreases. Also, it could be seen that the light emitting peaks had bandwidths of lower than 50 nm when the phosphors were excited by a light source having an excitement wavelength of 440 nm±40 nm.

### Experimental Example 2

### X-Ray Diffraction Analysis

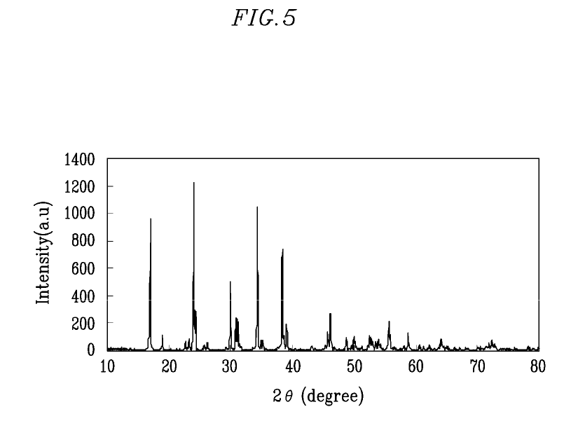

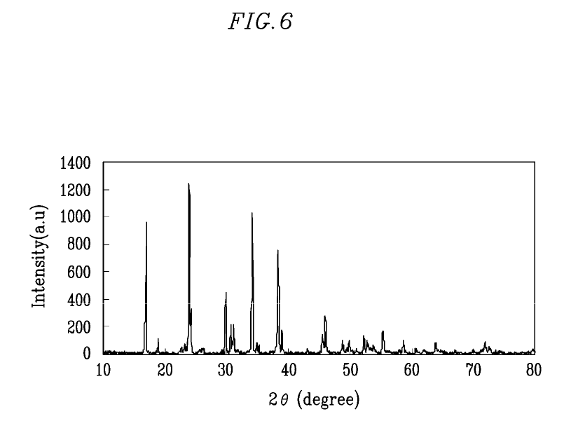

A CuKα radiation source was applied to the phosphor of Examples 1 and 4, and their XRD diffraction patterns were acquired by scanning the samples for 15 minutes with a 2θ of 10° to 80°. The results are respectively shown in FIGS. 5 and 6.

FIG. 5 shows an XRD diffraction pattern of the phosphor prepared according to Example 1, and FIG. 6 shows an XRD diffraction pattern of a phosphor prepared according to Example 4.

Referring to FIGS. 5 and 6, since barium was positioned in the crystalline structure of the phosphor, a crystal lattice constant was changed and the entire peaks shifted to the left. The peaks of FIG. 5 shifted to the left when compared to XRD diffraction pattern of pure strontium thiogallate, and the peaks of FIG. 6 shifted to the left more than the peaks of FIG. 5.

### Experimental Example 3

### Brightness and Color Coordinate Characteristic Analysis

Brightness and XY color coordinates of the phosphors prepared according to the Examples 1, 2, 3, 4, and 5 were measured and are shown in the following Table 1. The reference phosphor was SrGa₂S₂:Eu²⁺, and known BaGa₂S₄:Eu was used for comparison.

TABLE 1

| | | Bright- | Relative | | |
|---|---|---|---|---|---|
| | | ness | brightness | | |
| | Ba content | (cd/m²) | (%) | X | Y |
| SrGa₂S₄:0.04Eu²⁺ | 0 mol % | 4737 | 100 | 0.2724 | 0.7035 |
| Example 1 | 5 mol % | 5043 | 106 | 0.2688 | 0.7042 |
| Example 2 | 10 mol % | 4757 | 100 | 0.2591 | 0.7074 |
| Example 3 | 15 mol % | 4819 | 102 | 0.2518 | 0.7095 |
| Example 4 | 20 mol % | 4809 | 101 | 0.2504 | 0.7092 |
| Example 5 | 25 mol % | 4721 | 100 | 0.2488 | 0.7089 |
| BaGa₂S₄:Eu | 100 mol % | 4568 | 96 | 0.1430 | 0.5170 |

It can be seen from Table 1 that increasing the Ba quantity in the phosphors leads to increasing brightness. Also, the XY color coordinate characteristics showed that the color purity of green was increased. In the case of the phosphor BaGa₂S₄:Eu, the brightness was low and its (x,y) color coordinates showed bluish-green instead of green, which means that the color purity is low. In conclusion, it can be seen that the phosphor including Ba prepared according to aspects of the present invention can produce a green color having a higher color purity while increasing the brightness.

### Experimental Example 4

### Lifespan Characteristic Analysis

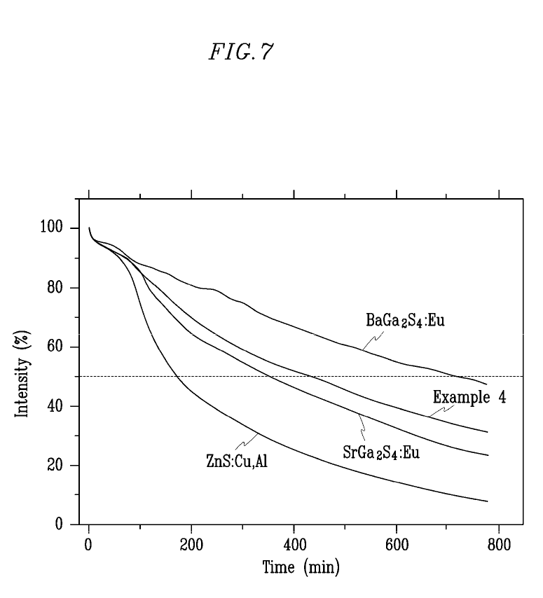

The light emission intensities of the phosphor prepared according to Example 4 and conventional phosphors BaGa₂S₄:Eu, SrGa₂S₄:Eu, and ZnS:(Cu,Al) were measured according to time, and the results are presented in FIG. 7.

Referring to FIG. 7, the phosphor prepared according to Example 4 of the present invention showed relatively acceptable variance in the light emission intensity over time. And, the phosphor according to Example 4 exhibited superior performance over the conventional phosphors SrGa₂S₄:Eu and ZnS:(Cu,Al). The phosphor BaGa₂S₄:Eu had an excellent lifespan but the phosphor BaGa₂S₄:Eu realized a bluish green color, as shown in Experimental Example 3, and had a low brightness. Thus, the phosphor BaGa₂S₄:Eu is not appropriate for use as a lone phosphor of a light emitting device.

### Example 6

### Fabrication of the Light Emission Unit

A white phosphor layer was formed by disposing dark-colored layers in the valid area of a substrate with graphite, and disposing a white phosphor layer in every pixel region between the dark-colored layers. Herein, the white phosphor layer was prepared by mixing a blue phosphor ZnS:(Ag, Cl), a red phosphor Y₂O₃:Eu, and the green phosphor of Example 1, at a mixing ratio of 30:21:14.

Subsequently, Al was deposited on the entire surface of the substrate with the white phosphor layer disposed thereon by using chemical vapor deposition to form a reflective metal layer. The substrate with the white phosphor layer and the reflective metal layer disposed thereon was baked at 470° C. for one hour to prepare a light emission unit.

The green emitting phosphor according to aspects of the current invention can be applied to a light emitting device as the light emission peaks at a shorter wavelength, the color coordinate characteristics are improved, and the lifespan of the light emitting device is improved when compared to the related art.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A green emitting phosphor having the empirical formula:
Sr₁₋ₓBaₓGa₂S₄:yEu²⁺
wherein 0.01≦x≦0.9 and 0.01≦y≦0.1.

2. The green emitting phosphor of claim 1, wherein 0.01≦x≦0.3 and 0.01≦y≦0.08.

3. The green emitting phosphor of claim 1, wherein 0.01≦x≦0.25 and 0.01≦y≦0.05.

4. The green emitting phosphor of claim 1, wherein the green emitting phosphor has light emitting peaks ranging from 522 to 535 nm.

5. The green emitting phosphor of claim 1, wherein the green emitting phosphor has light emitting peaks with a bandwidth of less than 50 nm under excitement by a light source having light emitting peaks of 440 nm±40 nm.

6. A light emitting device, comprising:
a first substrate and a second substrate disposed oppositely to each other;
an electron emission unit disposed on one side of the first substrate; and
a light emission unit disposed on one side of the second substrate,
wherein the light emission unit comprises a plurality of phosphor layers on one side of the second substrate, the phosphor layers comprising red, green, and blue phosphors, and the green phosphor comprises a green emitting phosphor having the following empirical formula:
Sr₁₋ₓBaₓGa₂S₄:yEu²⁺
wherein 0.01≦x≦0.9 and 0.01≦y≦0.1.

7. The light emitting device of claim 6, wherein 0.01≦x≦0.3 and 0.01≦y≦0.08.

8. The light emitting device of claim 6, wherein 0.01≦x≦0.25 and 0.01≦y≦0.05.

9. The light emitting device of claim 6, wherein the green emitting phosphor has light emitting peaks ranging from 522 to 535 nm.

10. The light emitting device of claim 6, wherein the green emitting phosphor has light emitting peaks with a bandwidth of less than 50 nm under excitement by a light source having light emitting peaks of 440 nm±40 nm.

11. The light emitting device of claim 6, wherein the light emission unit comprises a reflective metal layer disposed on the phosphor layers, and the reflective metal layer is an anode.

12. The light emitting device of claim 6, wherein the light emission unit further comprises:
an anode formed of a transparent conductive layer and disposed between the second substrate and the phosphor layers; and
a reflective metal layer disposed on the phosphor layers.

13. The light emitting device of claim 6, wherein the electron emission unit comprises:
first electrodes disposed on the first substrate in a direction;
second electrodes disposed in another direction crossing the first electrodes;
an insulation layer disposed between the first and the second electrodes; and
electron emission regions electrically connected to the first electrodes.

14. The light emitting device of claim 13, wherein the electron emission regions are formed of a material selected from the group consisting of a carbon-based material, a nano-sized material, and combinations thereof.

15. A liquid crystal display device, comprising:
a light emitting device comprising:
a first substrate and a second substrate disposed oppositely to each other;
an electron emission unit disposed on one side of the first substrate; and
a light emission unit disposed on one side of the second substrate,
wherein the light emission unit comprises a plurality of phosphor layers on one side of the second substrate, the phosphor layers comprising red, green, and blue phosphors, and the green phosphor comprising a green emitting phosphor having the following empirical formula:
Sr₁₋ₓBaₓGa₂S₄:yEu²⁺
wherein 0.01≦x≦0.9 and 0.01≦y≦0.1; and
a liquid crystal panel assembly disposed in a fore part of the light emitting device to display images by receiving light emitted from the light emitting device.

16. The liquid crystal display device of claim 15, wherein 0.01≦x≦0.3 and 0.01≦y≦0.08.

17. The liquid crystal display device of claim 15, wherein 0.01≦x≦0.25 and 0.01≦y≦0.05.

18. The liquid crystal display device of claim 15, wherein the green emitting phosphor of Formula 1 has light emitting peaks ranging from 522 to 535 nm.

19. The liquid crystal display device of claim 15, wherein the green emitting phosphor has light emitting peaks with a bandwidth of less than 50 nm under excitement by a light source having light emitting peaks of 440 nm±40 nm.

20. The liquid crystal display device of claim 15, wherein the light emission unit further comprises a reflective metal layer disposed on the phosphor layers, and the reflective metal layer is an anode.

21. The liquid crystal display device of claim 15, wherein the light emission unit further comprises:
an anode formed of a transparent conductive layer and disposed between the second substrate and the phosphor layers; and
a reflective metal layer disposed on the phosphor layers.

22. The liquid crystal display device of claim 15, wherein the electron emission unit comprises:
first electrodes disposed on the first substrate in a direction;
second electrodes disposed in another direction crossing the first electrodes;
an insulation layer disposed between the first and the second electrodes; and
electron emission regions electrically connected to the first electrodes.

23. The liquid crystal display device of claim 22, wherein the electron emission regions are formed of a material selected from the group consisting of a carbon-based material, a nano-sized material, and combinations thereof.

24. The light emitting device of claim 13, wherein the electron emission regions are formed as a carbon-based nano-structure.

25. The green emitting phosphor of claim 1, wherein the green emitting phosphor emits light having XY color coordinates of about 0.2200≦X≦0.2724 and 0.7010≦Y≦0.7095.

26. The green emitting phosphor of claim 25, wherein the green emitting phosphor emits light having XY color coordinates of about 0.2488≦x≦0.2700 and 0.7035≦y≦0.7040.
